(19) United States
(12) Patent Application Publication
(10) Pub. No.: US 2023/0162397 A1
(43) Pub. Date: May 25, 2023

(54) TEMPERATURE CORRECTION METHOD, DEVICE AND SYSTEM

(71) Applicant: MEGVII (BEIJING) TECHNOLOGY CO., LTD., Beijing (CN)

(72) Inventors: Yaowei ZHANG, Beijing (CN); Shuchang ZHOU, Beijing (CN); Chen HU, Beijing (CN)

(21) Appl. No.: 17/795,176

(22) PCT Filed: Sep. 30, 2020
(86) PCT No.: PCT/CN2020/119468

§ 371 Date: Feb. 9, 2023

(30) Foreign Application Priority Data
Apr. 7, 2020 (CN) 202010267395.7

(51) Int. Cl. G06T 7/80; G06T 7/55; G06T 7/246; G06V 40/16

(52) U.S. Cl. CPC G06T 7/80; G06T 7/55; G06T 7/248; G06V 40/178; G06V 40/171; G06T 2207/20084; G06T 2207/30201; G06T 2207/10048; G06T 2207/10028

(57) ABSTRACT

The present disclosure provides a temperature correcting method, apparatus and system, which relates to the technical field of computers. The method includes: acquiring a target reference image-frame pair containing a person, wherein the target reference image-frame pair includes a target visible-light image frame and a target thermal-imaging image frame; converting the target visible-light image frame into a depth image frame; inputting the depth image frame and the target thermal-imaging image frame into an atmosphere-inverse-scattering model, wherein the atmosphere-inverse-scattering model refers to a neural network model obtained by fitting a relation between depths and temperature correcting values in advance; and by using the atmosphere-inverse-scattering model, based on the depth image frame, performing temperature correction to the target thermal-imaging image frame, to obtain a target temperature. The present disclosure may effectively increase the accuracy of person temperature measurement.

### CROSS REFERENCE TO RELEVANT APPLICATIONS

The present application claims the priority of the Chinese patent application filed on Apr. 7, 2020 before the Chinese Patent Office with the application number of 202010267395.7 and the title of “TEMPERATURE CORRECTION METHOD, DEVICE AND SYSTEM”, which is incorporated herein in its entirety by reference.

### TECHNICAL FIELD

The present disclosure relates to the technical field of computers, and particularly relates to a temperature correcting method, an apparatus and a system.

### BACKGROUND

Regarding most of epidemic infectious diseases such as COVID-19 and flu, fever and high temperature are commonly seen prominent features of the suspected pathogen carriers. In this case, when an epidemic situation breaks out, there will usually be a large demand on body-temperature detecting devices. Currently, the commonly used body-temperature detecting technique is mainly the infrared-imaging technique, and the infrared-imaging technique is used to detect a thermal-imaging image of a target object, wherein the thermal-imaging image is an image that records the temperature of an object such as a person.

### SUMMARY

The object of the present disclosure includes, for example, to provide a temperature correcting method, an apparatus and a system, which can effectively increase the accuracy of person temperature measurement.

An embodiment of the present disclosure provides a temperature correcting method, wherein the method includes:

acquiring a target reference image-frame pair containing a person, wherein the target reference image-frame pair includes a target visible-light image frame and a target thermal-imaging image frame;

converting the target visible-light image frame into a depth image frame;

inputting the depth image frame and the target thermal-imaging image frame into an atmosphere-inverse-scattering model, wherein the atmosphere-inverse-scattering model refers to a neural network model obtained by fitting a relation between depths and temperature correcting values in advance; and

by using the atmosphere-inverse-scattering model, based on the depth image frame, performing temperature correction to the target thermal-imaging image frame, to obtain a target temperature.

In one or more embodiments, the method further includes:

according to a tracking algorithm, determining tracking information of the person in the target visible-light image frame, wherein the tracking information includes locating information and a tracking ID;

the locating information includes position information of a human face and/or a human body in the target visible-light image frame; and

the tracking ID is configured for identifying different persons in the target visible-light image frame, and a same person has a same tracking ID in different visible-light image frames.

In one or more embodiments, the step of, by using the atmosphere-inverse-scattering model, based on the depth image frame, performing temperature correction to the target thermal-imaging image frame, to obtain the target temperature includes:

by using the atmosphere-inverse-scattering model, according to the locating information of a target person, extracting pixel-depth values of the depth image frame and pixel-temperature values of the target thermal-imaging image frame, wherein the target person is determined based on the tracking ID;

according to the relation between the depths and the temperature correcting values, determining temperature correcting values corresponding to the pixel-depth values; and

according to the temperature correcting values, correcting the pixel-temperature values, to obtain a target temperature of the target person.

In one or more embodiments, the temperature correcting values corresponding to the pixel-depth values determined according to the relation between the depths and the temperature correcting values are a first temperature correcting value.

In one or more embodiments, the step of, by using the atmosphere-inverse-scattering model, based on the depth image frame, performing temperature correction to the target thermal-imaging image frame, to obtain the target temperature includes:

by using the relation between the depths and the temperature correcting values in the atmosphere-inverse-scattering model, based on the depth image frame, determining a first temperature correcting value; and

according to the first temperature correcting value and a predetermined temperature-correction factor, performing temperature correction to the target thermal-imaging image frame, to obtain a target temperature of a target person, wherein the predetermined temperature-correction factor includes a gender-age correction factor and/or a time correction factor, and the target person is determined based on the tracking ID.

In one or more embodiments, the step of, by using the atmosphere-inverse-scattering model, based on the depth image frame, performing temperature correction to the target thermal-imaging image frame, to obtain the target temperature includes:

by using the atmosphere-inverse-scattering model, according to the locating information of a target person, extracting pixel-depth values of the depth image frame and pixel-temperature values of the target thermal-imaging image frame;

according to the relation between the depths and the temperature correcting values, determining a first temperature correcting value corresponding to the pixel-depth values; and

according to the first temperature correcting value and a predetermined temperature-correction factor, performing temperature correction to the target thermal-imaging image frame, to obtain a target temperature of a target person, wherein the predetermined temperature-correction factor includes a gender-age correction factor and/or a time correction factor, and the target person is determined based on the tracking ID.

In one or more embodiments, the step of, according to the first temperature correcting value and the predetermined temperature-correction factor, performing temperature correction to the target thermal-imaging image frame, to obtain the target temperature of the target person includes:

according to the gender-age correction factor and a predetermined gender-age mapping table, determining a second temperature correcting value of the target person, wherein the gender-age mapping table records the temperature correcting values that correspond to different genders and different age intervals; and/or, according to the time correction factor and a predetermined time mapping table, determining a third temperature correcting value of the target person, wherein the time mapping table records the temperature correcting values that correspond to different time intervals;

according to a preset weight, weighting the first temperature correcting value with the second temperature correcting value and/or the third temperature correcting value, to obtain a target temperature correcting value; and

according to the target temperature correcting value, correcting the pixel-temperature values within a locating block of the target thermal-imaging image frame, to obtain the target temperature of the target person, wherein the locating block is determined based on the locating information of the target person.

In one or more embodiments, the step of, according to the first temperature correcting value and the predetermined temperature-correction factor, performing temperature correction to the target thermal-imaging image frame, to obtain the target temperature of the target person includes:

according to the first temperature correcting value, correcting the pixel-temperature values within the locating block of the target thermal-imaging image frame, to obtain a first corrected thermal-imaging image frame of the target thermal-imaging image frame, wherein the locating block is determined based on the locating information of the target person; and

according to the gender-age correction factor and/or the time correction factor, performing secondary correction to pixel-temperature values within a locating block of the first corrected thermal-imaging image frame, to obtain the target temperature of the target person.

In one or more embodiments, the step of, according to the gender-age correction factor and/or the time correction factor, performing secondary correction to pixel-temperature values within the locating block of the first corrected thermal-imaging image frame, to obtain the target temperature of the target person includes:

according to the gender-age correction factor, correcting the pixel-temperature values distributed within the locating block of the first corrected thermal-imaging image frame, to obtain a second corrected thermal-imaging image frame;

according to the time correction factor, correcting the pixel-temperature values distributed within the locating block of the second corrected thermal-imaging image frame, to obtain a third corrected thermal-imaging image frame; and

according to the pixel-temperature values that have been corrected that are distributed within the locating block of the third corrected thermal-imaging image frame, determining the target temperature of the target person.

In one or more embodiments, the step of, according to the gender-age correction factor, performing secondary correction to the pixel-temperature values within the locating block of the first corrected thermal-imaging image frame includes:

extracting a human-face feature of the target person in the target visible-light image frame;

according to the human-face feature, identifying gender-age information of the target person; and

according to the gender-age information and a preset gender-age mapping table, performing secondary correction to pixel-temperature values distributed within the locating block of the first corrected thermal-imaging image frame, wherein the gender-age mapping table records the temperature correcting values that correspond to different genders and different age intervals.

In one or more embodiments, the step of, according to the time correction factor, performing secondary correction to the pixel-temperature values within the locating block of the first corrected thermal-imaging image frame includes:

acquiring a photographing time of the target reference image-frame pair; and

according to the photographing time and a preset time mapping table, performing secondary correction to pixel-temperature values distributed within the locating block of the first corrected thermal-imaging image frame, wherein the time mapping table records the temperature correcting values that correspond to different time intervals.

In one or more embodiments, the method further includes:

according to the target visible-light image frame, determining a photographing distance between the person and a device photographing the target reference image-frame pair; and

based on the photographing distance and a predetermined temperature-correction factor, performing temperature correction to the target thermal-imaging image frame, wherein the predetermined temperature-correction factor includes a gender-age correction factor and/or a time correction factor.

In one or more embodiments, the step of, according to the target visible-light image frame, determining the photographing distance between the person and the device photographing the target reference image-frame pair includes:

according to position information corresponding to a human face of a target person in the target visible-light image frame, determining a pixel ratio of a human-face region of the target person to the target visible-light image frame, wherein the target person is determined based on the tracking ID; and

according to the pixel ratio, determining the photographing distance between the target person and the device photographing the target reference image-frame pair.

In one or more embodiments, the step of acquiring the target reference image-frame pair containing the person includes:

by using a two-light camera, performing image acquisition to a specified region, to obtain a plurality of original reference image-frame pairs, wherein the two-light camera includes a visible-light camera and an infrared camera, and an original visible-light image frame collected by the visible-light camera and an original thermal-imaging image frame collected by the infrared camera correspond to each other, to form each of the original reference image-frame pairs;

by performing human-face detection to the original visible-light image frames, determining the target visible-light image frame containing the person among the original visible-light image frames; and

determining the original reference image-frame pair corresponding to the target visible-light image frame to be the target reference image-frame pair containing the person.

In one or more embodiments, the step of converting the target visible-light image frame into the depth image frame includes:

inputting the target visible-light image frame into a predetermined depth-image converting model, and by using the depth-image converting model, converting the target visible-light image frame into the depth image frame.

In one or more embodiments, the method further includes:

according to the target temperatures of the persons and a preset temperature threshold, determining a fever person in the target visible-light image frame, and acquiring a target tracking ID of the fever person;

from other reference image-frame pairs within a preset duration from the target reference image-frame pair, acquiring a plurality of visible-light image frames to be tracked having the target tracking ID; and

according to photographing times and photographing locations of the visible-light image frames to be tracked, tracking the fever person.

An embodiment of the present disclosure further provides a temperature correcting apparatus, wherein the apparatus includes:

an image acquiring module configured for acquiring a target reference image-frame pair containing a person, wherein the target reference image-frame pair includes a target visible-light image frame and a target thermal-imaging image frame;

an image converting module configured for converting the target visible-light image frame into a depth image frame;

an image inputting module configured for inputting the depth image frame and the target thermal-imaging image frame into an atmosphere-inverse-scattering model, wherein the atmosphere-inverse-scattering model refers to a neural network model obtained by fitting a relation between depths and temperature correcting values in advance; and

a temperature correcting module configured for, by using the atmosphere-inverse-scattering model, based on the depth image frame, performing temperature correction to the target thermal-imaging image frame, to obtain a target temperature.

An embodiment of the present disclosure provides a temperature correcting system, wherein the system includes: an image collecting device, a processor and a storage device;

the image collecting device is configured for collecting a target reference image-frame pair; and

the storage device stores a computer program, and the computer program, when executed by the processor, executes the method stated herein.

An embodiment of the present disclosure provides a computer-readable storage medium, the computer-readable storage medium storing a computer program, wherein the computer program, when executed by a processor, executes the steps of the method stated herein.

The inventor has found that, in the prior art, in the field of infrared temperature measurement, the distance between the infrared device photographing the thermal image and the object highly influences the result of the temperature detection of the thermal-imaging image, which causes a low accuracy of the result of the temperature measurement. Particularly, in the detection of the body temperature of a disease-related subject, that results in determining a health subject of a normal body temperature to be a disease patient, or determining a disease patient of a body temperature exceeding a threshold to be a health person.

The embodiments of the present disclosure provide a temperature correcting method, apparatus and system, wherein the method includes, after acquiring a target visible-light image frame and a target thermal-imaging image frame that contain a person, firstly converting the target visible-light image frame into a depth image frame; subsequently inputting the depth image frame and the target thermal-imaging image frame into an atmosphere-inverse-scattering model, wherein the atmosphere-inverse-scattering model refers to a neural network model obtained by fitting a relation between depths and temperature correcting values in advance; and finally by using the atmosphere-inverse-scattering model, based on the depth image frame, performing temperature correction to the target thermal-imaging image frame, to obtain a target temperature. As compared with the determination of the person temperature directly based on the detected target thermal-imaging image frame in the prior art, the above-described mode of using the atmosphere-inverse-scattering model to perform the temperature correction cannot only ensure a high efficiency of the temperature detection, but also effectively utilizes the relation between the depths and the temperature correcting values to correct the person temperature, thereby obtaining a more accurate result. Because the depth indicates the distance between the camera and the person, such a mode takes into consideration and corrects the influence on the temperature by the distance, which can, in non-contacting temperature measurement, effectively increase the accuracy of person temperature measurement.

The other characteristics and advantages of the present disclosure will be described in the subsequent description. Alternatively, some of the characteristics and advantages can be inferred or unambiguously determined from the description, or can be known by implementing the above-described technical solutions of the present disclosure.

In order to make the above purposes, features and advantages of the present disclosure more apparent and understandable, the present disclosure will be described in detail below with reference to the preferable embodiments and the drawings.

### BRIEF DESCRIPTION OF THE DRAWINGS

In order to more clearly illustrate the technical solutions of the particular embodiments of the present disclosure or the prior art, the figures that are required to describe the particular embodiments or the prior art will be briefly introduced below. Apparently, the figures that are described below are embodiments of the present disclosure, and a person skilled in the art can obtain other figures according to these figures without paying creative work.

FIG. 1 shows a schematic structural diagram of the electronic device according to an embodiment of the present disclosure;

FIG. 2 shows a flow chart of the temperature correcting method according to an embodiment of the present disclosure;

FIG. 3 shows a schematic diagram of the temperature correcting mode according to an embodiment of the present disclosure;

FIG. 4 shows a schematic diagram of the temperature correcting mode according to another embodiment of the present disclosure; and

FIG. 5 shows a structural block diagram of the temperature correcting apparatus according to an embodiment of the present disclosure.

### DETAILED DESCRIPTION

In order to make the objects, the technical solutions and the advantages of the embodiments of the present disclosure clearer, the technical solutions of the present disclosure will be clearly and completely described below with reference to the drawings. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

In conventional body-temperature detecting techniques, the result of the body-temperature detection is highly influenced by the distance between the temperature measuring device (for example, an infrared device) and the object whose temperature is measured, which usually causes a low accuracy of the result of the temperature measurement. In view of that, the embodiments of the present disclosure provide a temperature correcting method, apparatus and system. The temperature correcting method, apparatus and system may be, at body-temperature quarantining locations such as a community, a train station and a hospital, applied for functions such as monitoring, detection and measurement of human-body temperature, and may also be applied in scenes of monitoring, detection and measurement of the temperature of objects such as a water cup and a mobile phone. In order to facilitate the comprehension, the embodiments of the present disclosure will be described in detail below.

The embodiments

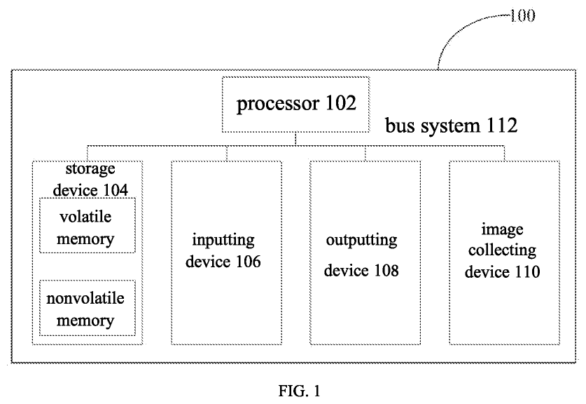

Firstly, an exemplary electronic device 100 for implementing the temperature correcting method, apparatus and system according to the embodiments of the present disclosure is described with reference to FIG. 1.

FIG. 1 shows a schematic structural diagram of an electronic device. The electronic device 100 includes one or more processors 102, one or more storage devices 104, an inputting device 106, an outputting device 108 and an image collecting device 110, and those components are interconnected by a bus system 112 and/or a connecting mechanism in another form (not shown). It should be noted that the components and the structure of the electronic device 100 shown in FIG. 1 are merely exemplary, rather than limiting, and, according to demands, the electronic device may have some of the components shown in FIG. 1, and may also have other components and structures not shown in FIG. 1. For example, two or more components of the electronic device 100 are wirelessly connected, for example, by Bluetooth, wireless fidelity (Wi-Fi) or Internet of Things.

The processors 102 may be a central processing unit (CPU) or a processing unit in another form having a data handling capacity and/or an instruction executing capacity, and may control the other components in the electronic device 100 to perform the desired functions.

The storage device 104 may include one or more computer program products. The computer program products may include various types of computer-readable storage mediums, such as a volatile memory and/or a nonvolatile memory. The volatile memory includes, for example, a random access memory (RAM) and/or a cache and so on. The nonvolatile memory includes, for example, a read-only memory (ROM), a hard disk, a flash memory and so on. The computer-readable storage mediums store one or more computer program instructions, and the processor 102 may execute the program instructions, to realize the client functions according to the embodiments of the present disclosure described below (realized by the processor) and/or other desired functions. The computer-readable storage mediums may further store various application programs and various data, for example, the various data used and/or generated by the application programs.

The inputting device 106 may be a device used by the user to input an instruction, and may include one or more of a keyboard, a mouse, a microphone, a touch screen and so on.

The outputting device 108 may output various information (for example, images or sounds) to the exterior (for example, the user), and may include one or more of a display, a loudspeaker and so on.

The image collecting device 110 may photograph an image desired by the user (such as a photograph, a video and so on), and store the photographed image in the storage device 104 for usage by the other components.

As an example, the exemplary electronic device for implementing the temperature correcting method, apparatus and system according to the embodiments of the present disclosure may be implemented in an intelligent terminal such as a smartphone, a camera, a temperature measuring device and a tablet personal computer.

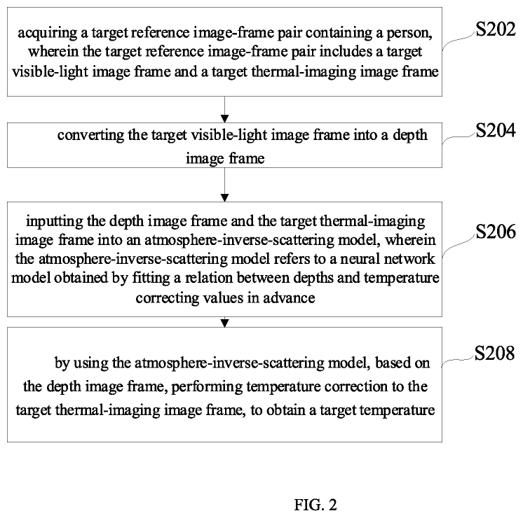

Referring to the flow chart of a temperature correcting method shown in FIG. 2, the method mainly includes the following step S202 to step S208:

Step S202: acquiring a target reference image-frame pair containing a person, wherein the target reference image-frame pair may be obtained by using a two-light camera to perform image acquisition to the person in a monitored region. The two-light camera refers to a combined camera of a double-camera structure, and the two-light camera according to the present embodiment refers to a combination of a visible-light camera and a thermal-imaging camera, in which the visible-light camera and the thermal-imaging camera are integrated by modes such as upper-lower arrangement and left-right arrangement. The target visible-light image frame containing the person collected by the visible-light camera and the target thermal-imaging image frame containing the person collected by the thermal-imaging camera correspond to each other, to form the target reference image-frame pair.

Step S204: converting the target visible-light image frame into a depth image frame. In an implementation, this step may include inputting the target visible-light image frame into a predetermined depth-image converting model, and by using the depth-image converting model, converting the target visible-light image frame into the depth image frame. The depth-image converting model, according to an internal-reference matrix of the visible-light camera and a pixel coordinate of the target visible-light image frame, outputs the depth image frame corresponding to the target visible-light image frame. The depth image that is obtained by the conversion uses the distances (depths) from the two-light camera to the points of the person as the pixel-depth values, wherein the pixel-depth values can reflect the degree of the photographing distance between the two-light camera and the person.

Step S206: inputting the depth image frame and the target thermal-imaging image frame into an atmosphere-inverse-scattering model, wherein the atmosphere-inverse-scattering model refers to a neural network model obtained by fitting a relation between depths and temperature correcting values in advance.

Step S208: by using the atmosphere-inverse-scattering model, based on the depth image frame, performing temperature correction to the target thermal-imaging image frame, to obtain a target temperature.

In the present embodiment, the atmosphere-inverse-scattering model may extract the pixel-depth values of the depth image frame and the pixel-temperature values of the person in the target thermal-imaging image frame, correct the pixel-temperature values according to the pixel-depth values and the relation between the depths and the temperature correcting values, and output the target temperature obtained by the temperature correction to the person.

The temperature correcting method according to the present embodiment includes, after acquiring a target visible-light image frame and a target thermal-imaging image frame that contain a person, firstly converting the target visible-light image frame into a depth image frame; subsequently inputting the depth image frame and the target thermal-imaging image frame into an atmosphere-inverse-scattering model, wherein the atmosphere-inverse-scattering model refers to a neural network model obtained by fitting a relation between depths and temperature correcting values in advance; and finally by using the atmosphere-inverse-scattering model, based on the depth image frame, performing temperature correction to the target thermal-imaging image frame, to obtain a target temperature. As compared with the determination of the person temperature directly based on the detected target thermal-imaging image frame in the prior art, the above-described mode of using the atmosphere-inverse-scattering model to perform the temperature correction cannot only ensure a high efficiency of the temperature detection, but also effectively utilizes the relation between the depths and the temperature correcting values to correct the person temperature, thereby obtaining a more accurate result. Because the depth indicates the distance between the camera and the person, such a mode takes into consideration and corrects the influence on the temperature by the distance, which can, in non-contacting temperature measurement, effectively increase the accuracy of person temperature measurement.

In an embodiment of the present disclosure, the target reference image-frame pair containing the person may particularly be acquired by using the following method:

Firstly, by using a two-light camera, performing image acquisition to a specified region, to obtain a plurality of original reference image-frame pairs, wherein an original visible-light image frame collected by the visible-light camera in the two-light camera and an original thermal-imaging image frame collected by the infrared camera correspond to each other, to form each of the original reference image-frame pairs; and

subsequently by performing human-face detection to the original visible-light image frames, determining the target visible-light image frame containing the person among the original visible-light image frames. The human-face detection to the original visible-light image frames may use conventional human-face detecting methods, for example, a human-face detecting method based on a convolutional neural network (R-CNN, Fast R-CNN, Faster R-CNN and so on). Those methods may determine whether an original visible-light image frame contains a person, and predict and generate the locating information of the person in the target visible-light image frames containing a person, wherein the locating information generally include position information of a human face and/or a human body in the target visible-light image frame.

All of the objects (such as a plant and a vehicle) besides the person in the target thermal-imaging image frame have a temperature value, and those objects do not only interfere the correction of the person temperature, but also add the calculation amount. Therefore, optionally, in the execution of the step S208, the temperature correction is performed merely to the region of the target thermal-imaging image frame where the person is located, so as to reduce the data volume of the temperature correction, and increase the efficiency of the temperature correction. In order to acquire the region of at least one person in the target thermal-imaging image frame, there is provided a person tracking method, including the following steps: according to a tracking algorithm, determining tracking information of the person in the target visible-light image frame, wherein the tracking information includes locating information and a tracking ID; the locating information includes position information of a human face and/or a human body in the target visible-light image frame; and the tracking ID is configured for identifying different persons in the target visible-light image frame, and a same person has a same tracking ID in different visible-light image frames.

In practical application scenes, the target visible-light image frame is generally a plurality of frames in a successive image-frame sequence, and the plurality of target visible-light image frames contain the same one person. When the whole body of the person in the target visible-light image frames is not blocked, the locating information includes the position information in the target visible-light image frames. When the person in the target visible-light image frames is partially blocked, for example at the face or the trunk, the locating information includes the position information of the parts not blocked, for example the human face or the human body, in the target visible-light image frames.

It can be understood that, because the depth image frame is obtained by converting the target visible-light image frame, after the tracking information of the person in the target visible-light image frame has been determined, the tracking information of the person in the depth image frame may be determined.

Regarding the mode of determining the tracking information of the person in the target thermal-imaging image frame, in practical applications, because of the mode of the spatial arrangement of the visible-light camera and the thermal-imaging camera in the two-light camera, the visible-light image frame and the infrared-light image frame that are photographed cannot completely align, and have a certain spatial deviation therebetween. In order to ameliorate the deviation of the tracking information caused by the spatial deviation between the image frames, the present embodiment may, according to the mode of the spatial arrangement of the visible-light camera and the thermal-imaging camera, by using the parameters of the cameras, predetermine the position correspondence relation of the visible-light image frame and the infrared-light image frame, and subsequently, according to the position correspondence relation and the tracking information of the person in the target visible-light image frame, accurately determine the tracking information of the person in the target thermal-imaging image frame.

Based on the tracking information of the person determined by using the above-described method, the step of, by using the atmosphere-inverse-scattering model, performing the temperature correction to the target thermal-imaging image frame in the step S208 may be implemented by using the following steps (1) to (3):

(1) by using the atmosphere-inverse-scattering model, according to the locating information of a target person, extracting pixel-depth values of the depth image frame and pixel-temperature values of the target thermal-imaging image frame, wherein the target person is determined based on the tracking ID. This step may, according to the tracking IDs, regard the persons as the target person one by one, and may also regard every person as the target persons, and distinguish the different target persons by using the tracking IDs.

Based on the locating information, the locating block of the person in the target visible-light image frame may be determined, wherein the locating block contains one or more position blocks corresponding to the human face and/or the human body. By using the atmosphere-inverse-scattering model, the pixel-depth values within the locating block where the target person is located in the depth image frame and the pixel-temperature values within the locating block where the target person is located in the target thermal-imaging image frame are extracted. That may reduce the quantity of the pixel-depth values and the pixel-temperature values that are extracted, increase the efficiency of the extraction by the atmosphere-inverse-scattering model, and facilitate to reduce the interference by the temperatures of other objects, to increase the efficiency and the accuracy of the subsequent temperature correction.

(2) according to the relation between the depths and the temperature correcting values, determining temperature correcting values corresponding to the pixel-depth values. The relation between the depths and the temperature correcting values may be expressed by using a curve or a function. Each of the depth corresponds to a matching temperature correcting value, wherein the temperature correcting value may be positive or negative, and, based on that, the temperature correcting values corresponding to the pixel-depth values are determined. The pixel-depth values within the locating block where the target person is located are generally a plurality of pixel-depth values, and the present embodiment may, according to the relation between the depths and the temperature correcting values, determine the temperature correcting values corresponding to each of the pixel-depth values, and may also firstly, according to the pixel-depth values within the locating block where the target person is located, determine a representative of the pixel-depth values, wherein the representative of the pixel-depth values is, for example, the mean value, the mode, the median and so on of the plurality of pixel-depth values, and subsequently, according to the relation between the depths and the temperature correcting values, determine the temperature correcting value corresponding to the representative of the pixel-depth values.

(3) according to the temperature correcting values, correcting the pixel-temperature values, to obtain a target temperature of the target person.

In the present embodiment, optionally, the temperature correcting value may be the temperature correcting values corresponding to each of the pixel-depth values, in which case the pixel-temperature values at the corresponding pixel positions in the target thermal-imaging image frame are corrected according to the temperature correcting values, wherein the corresponding pixel positions in the target thermal-imaging image frame are acquired based on the position correspondence relation between the target visible-light image frame and the target thermal-imaging image frame. Optionally, the temperature correcting value may be the temperature correcting value corresponding to the representative of the pixel-depth values, in which case firstly a representative of the pixel-temperature values is determined according to the pixel-temperature values within the locating block where the target person is located, and subsequently the representative of the pixel-temperature values is corrected according to the temperature correcting value.

In the correction, the temperature correcting values and the pixel-temperature values may be added. When the temperature correcting values are negative, as compared with the uncorrected pixel-temperature values, the target temperature that has been corrected is reduced. When the temperature correcting values are positive, as compared with the uncorrected pixel-temperature values, the target temperature that has been corrected is increased.

The temperature correcting mode according to the present embodiment may, based on the locating information, perform the temperature correction merely to the image region where the person is located, which may reduce the interference on the correction of the person temperature by objects such as a plant and a vehicle, to increase the accuracy of the temperature, and may reduce the calculation amount, to increase the efficiency of the temperature correction.

It has been taken into consideration that, besides the large influence on the temperature in the thermal-imaging image frame by the factor of the depth (i.e., the distance between the photographing device and the person), many factors such as the age, the gender and the ambient temperature also influence the accuracy of the temperature measurement. In view of that, optionally, in the process of the temperature correction to the person in the target thermal-imaging image frame, the temperature value of the person in the target thermal-imaging image frame may be corrected based on the depth/distance correction factor in combination with other temperature-correction factors, with reference to the following step (I) and step (II):

(I) by using the relation between the depths and the temperature correcting values in the atmosphere-inverse-scattering model, based on the depth image frame, determining a first temperature correcting value. This step may include, by using the atmosphere-inverse-scattering model, firstly extracting the pixel-depth values and the pixel-temperature values, subsequently according to the relation between the depths and the temperature correcting values, determining a first temperature correcting value corresponding to the pixel-depth values. The particular implementation mode may refer to the above-described step (1) and step (2), and is not described in detail herein.

(II) according to the first temperature correcting value and a predetermined temperature-correction factor, performing temperature correction to the target thermal-imaging image frame, to obtain a target temperature of a target person, wherein the predetermined temperature-correction factor may include but is not limited to a gender-age correction factor and/or a time correction factor. The gender-age correction factor is a temperature-correction factor provided for the difference in the body temperatures of population of different age groups and different genders. The time correction factor is a temperature-correction factor provided for the difference in the body temperatures of the person in the different time periods of a day.

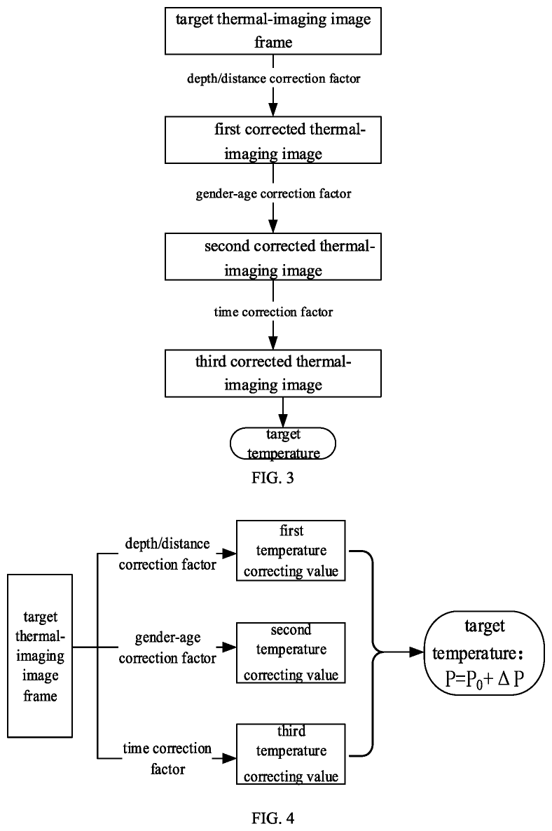

In order to facilitate the comprehension, referring to FIG. 3, an alternative embodiment of, according to the first temperature correcting value and a predetermined temperature-correction factor, performing temperature correction to the target thermal-imaging image frame is provided, with reference to the following step 1 and step 2:

Step 1: according to the first temperature correcting value, correcting the pixel-temperature values within the locating block of the target thermal-imaging image frame, to obtain a first corrected thermal-imaging image frame of the target thermal-imaging image frame, wherein the locating block is determined based on the locating information of the target person.

In a particular implementation, this step includes firstly according to the first temperature correcting value, correcting the pixel-temperature values within the locating block of the target thermal-imaging image frame, to obtain the pixel-temperature values that have been corrected within the locating block of the target thermal-imaging image frame; and subsequently, based on the pixel-temperature values that have been corrected within the locating block of the target thermal-imaging image frame and the initial pixel-temperature values within the other area (the area other than the locating block) of the target thermal-imaging image frame, obtaining a first corrected thermal-imaging image frame of the target thermal-imaging image frame.

Step 2: according to the gender-age correction factor and/or the time correction factor, performing secondary correction to pixel-temperature values within a locating block of the first corrected thermal-imaging image frame, to obtain a target temperature of a target person.

The gender-age correction factor and the time correction factor may be employed singly, and may also be employed together. Optionally, when the temperature within the locating block in the first corrected thermal-imaging image frame is further corrected according to both of the gender-age correction factor and the time correction factor, the order of the temperature corrections by the gender-age correction factor and the time correction factor is not limited in the present embodiment. For example, referring to FIG. 3, this step may include firstly according to the gender-age correction factor, correcting the pixel-temperature values distributed within the locating block of the first corrected thermal-imaging image frame, to obtain a second corrected thermal-imaging image frame; and subsequently according to the time correction factor, correcting the pixel-temperature values distributed within the locating block of the second corrected thermal-imaging image frame, to obtain a third corrected thermal-imaging image frame. In this case, the target temperature of the target person may be determined according to the pixel-temperature values that have been corrected that are distributed within the locating block of the third corrected thermal-imaging image frame, for example, by using the average value of the pixel-temperature values that have been corrected that are distributed within the locating block of the third corrected thermal-imaging image frame as the target temperature of the target person.

The particular temperature correcting modes using the gender-age correction factor and the time correction factor will be described individually below.

The step of, according to the gender-age correction factor, performing secondary correction to the pixel-temperature values within the locating block of the first corrected thermal-imaging image frame includes: (i) extracting a human-face feature of the target person in the target visible-light image frame; and according to the human-face feature, identifying gender-age information of the target person. For example, this step includes, by using a deep learning network model, performing feature extraction to the position block corresponding to the human face of the person in the target visible-light image frame, to obtain the human-face feature; and according to the human-face feature, identifying gender-age information of the target person. The deep learning network model for identifying the gender-age information of the person is a conventional method itself, and its principle is not explained in detail herein. (ii) according to the gender-age information and the preset gender-age mapping table, performing secondary correction to pixel-temperature values distributed within the locating block of the first corrected thermal-imaging image frame. The gender-age mapping table may refer to the following Table 1, wherein Table 1 records the temperature correcting values that correspond to different genders and different age intervals. For example, the 3-10-year age interval corresponds to two temperature correcting values, which are the mapping value +0.5 for boys and the mapping value +0.8 for girls. Taking the mapping value (+0.5) for boys as an example, it represents adding 0.5 degree Celsius (° C.) to the temperature of a boy in the first corrected thermal-imaging image frame.

TABLE 1
gender-age mapping table

age

| gender | 0-2 years | 3-10 years | 12-20 years | >20 years |
|---|---|---|---|---|
| male | +1 | +0.5 | +0.3 | +0 |
| female | +1.3 | +0.8 | +0.5 | +0 |

In Table 1, the unit of the mapping values is degree Celsius (° C.).

The step of, according to the time correction factor, performing secondary correction to the pixel-temperature values within the locating block of the first corrected thermal-imaging image frame includes: acquiring a photographing time of the target reference image-frame pair; and according to the photographing time and the preset time mapping table, performing secondary correction to pixel-temperature values distributed within the locating block of the first corrected thermal-imaging image frame. The time mapping table may refer to the following Table 2, wherein Table 2 records the temperature correcting values that correspond to different time intervals. For example, the photographing time of the target reference image-frame pair is 8 o'clock, which is within the time interval of 6-10 o'clock, and the temperature correcting value corresponding to it is −0.5, which represents reducing 0.5 degree Celsius from the pixel-temperature values distributed within the locating block of the person in the first corrected thermal-imaging image frame.

TABLE 2
time mapping table

| | time interval | | | | |
|---|---|---|---|---|---|
| | 6-10 | 10-12 | 12-14 | 14-18 | 18-22 |
| | o'clock | o'clock | o'clock | o'clock | o'clock |
| temperature | −0.5 | +0.3 | +0.5 | +0 | −0.4 |
| correcting value | | | | | |

In Table 2, the unit of the temperature correcting values is degree Celsius (° C.).

By using the temperature correcting mode according to the present embodiment, the temperature of the person in the target corrected thermal-imaging image frame is sequentially corrected initially by using the distance and corrected again by using the predetermined temperature-correction factor, which can effectively increase the accuracy of person temperature measurement.

In another alternative implementation of the embodiments of the present disclosure, the above step (II) may also be implemented by using the temperature correcting mode shown in FIG. 4, wherein the mode may include the following step 1) to step 3):

Step 1): according to the gender-age correction factor and a predetermined gender-age mapping table, determining a second temperature correcting value of the target person; and/or, according to the time correction factor and a predetermined time mapping table, determining a third temperature correcting value of the target person. The gender-age mapping table may refer to the above Table 1, and the time mapping table may refer to the above Table 2.

Step 2): according to a preset weight, weighting the first temperature correcting value with the second temperature correcting value and/or the third temperature correcting value, to obtain a target temperature correcting value.

In a particular implementation, the target temperature correcting value may be obtained by using the following formula:

ΔP=λ₁ΔP₁+λ₂ΔP₂+λ₃ΔP₃

wherein ΔP is the target temperature correcting value, ΔP₁ is the first temperature correcting value, λ₁ is the weight corresponding to the first temperature correcting value, ΔP₂ is the second temperature correcting value, λ₂ is the weight corresponding to the second temperature correcting value, ΔP₃ is the third temperature correcting value, and λ₃ is the weight corresponding to the third temperature correcting value, wherein λ₁+λ₂+λ₃=1 and, in order to flexibly adapt for the actual body-temperature detection scenes, one or two of λ₁, λ₂ and λ₃ may be 0. For example, when λ₂ and λ₃ are 0, λ₁ is 1, which represents that, in the current body-temperature detection scene, the temperature is corrected merely based on the relation between the depths and the temperature correcting values. The above mode of obtaining the target temperature correcting value based on the weights may increase the accuracy of the body-temperature detection, and may adapt for the actual body-temperature detection scenes better, to properly reduce the calculation amount of the body temperature.

Step 3): according to the target temperature correcting value, correcting the pixel-temperature values within a locating block of the target thermal-imaging image frame. For example, referring to FIG. 4, the pixel-temperature values P₀ within the locating block and the target temperature correcting value ΔP are added, to obtain the target temperature P that has been corrected of the target person.

In the temperature correcting mode according to the present embodiment, by flexibly selecting the depth/distance correction factor, the gender-age correction factor and the time correction factor, the temperature correcting mode may adapt for the current body-temperature detection scene better, which facilitates to increase the accuracy of the body-temperature detection, and may control the magnitude of the calculation amount in the body-temperature correction process to a certain extent.

An embodiment of the present disclosure may further provide another temperature correcting method, with reference to the following step A to step C:

Step A: acquiring a target reference image-frame pair containing a person, wherein the target reference image-frame pair includes a target visible-light image frame and a target thermal-imaging image frame.

Step B: according to the target visible-light image frame, determining a photographing distance between the person and a device photographing the target reference image-frame pair.

It can be easily understood that, because the atmosphere has a certain effect of attenuation to the lights of different wavelengths entering the two-light camera, the photographing distance influences the accuracy of the temperature of the person reflected by the target thermal-imaging image frame. The present embodiment may correct the temperature of the person in the target thermal-imaging image frame based on the photographing distance, to obtain a more accurate person temperature, thereby solving the above problem well.

Because the photographing distance of the target visible-light image frame is usually equal to the photographing distance of the target thermal-imaging image frame (for example, when the two-light camera is used, the photographing distances are substantially equal), or may be determined based on the correspondence relation between the visible-light image frame and the thermal-imaging image frame and the photographing distance of the target thermal-imaging image frame, and usually the target visible-light image frame has a better quality and can accurately illustrate the relevant information of the target such as the face/human-body characteristics, the age and the gender, the photographing distance may be determined more accurately based on the target visible-light image frame.

Step C: based on the photographing distance, performing temperature correction to the target thermal-imaging image frame; or, based on the photographing distance and one or more predetermined temperature-correction factors, performing temperature correction to the target thermal-imaging image frame, wherein the predetermined temperature-correction factor includes a gender-age correction factor and/or a time correction factor. The temperature correcting mode may be in various manners. For example, the temperature correcting mode includes increasing or reducing the temperature in the target thermal-imaging image frame according to the photographing distance. As another example, the temperature correcting mode includes firstly fitting the relation between the photographing distance and the temperature attenuation, and subsequently correcting the temperature of the person in the target thermal-imaging image frame based on that relation. The particular implementation mode of the temperature correction may refer to the above-described temperature correcting mode based on the depth image frame, and is not described in detail herein.

As being similar to the temperature correcting method according to the multiple above-described embodiments, the temperature correcting method according to the present embodiment also takes into consideration and corrects the influence on the temperature by the distance. Moreover, in this mode, usually the visible-light image frame has a high image quality, and the photographing distance determined accordingly may have a high accuracy, whereby the temperature of the person is corrected by effectively using the photographing distance of a high accuracy. Therefore, the present disclosure may, in non-contacting temperature measurement, effectively increase the accuracy of person temperature measurement.

Taking into consideration the visual rule that everything looks smaller in the distance and bigger on the contrary, and that, in the order of the distance unit of meters, the sizes of the human faces and the human bodies of different persons may be approximately equal, a first embodiment of determining the photographing distance is provided, with reference to the following step 1) to step 2):

1) according to position information corresponding to a human face of a target person in the target visible-light image frame, determining a pixel ratio of a human-face region of the target person to the target visible-light image frame, wherein the target person is determined based on the tracking ID.

This step may particularly include firstly, according to the position information corresponding to the human face, determining the locating block of the human-face region, and counting up the quantity of first pixels within the position block of the human-face region; subsequently counting up the quantity of second pixels within the target visible-light image frame as a whole; and finally using the ratio of the quantity of the first pixels to the quantity of the second pixels as the pixel ratio of the human-face region of the target person in the target visible-light image frame.

2) according to the pixel ratio, determining the photographing distance between the target person and the device photographing the target reference image-frame pair. The pixel ratio may reflect the size of the human face in the image, and, by referring to the visual rule that everything looks smaller in the distance and bigger on the contrary, the photographing distance of the person may be determined according to the pixel ratio.

According to the depth image frame, a second embodiment of determining the photographing distance may be provided, with reference to the following step 1 to step 2:

Step 1: According to the locating information of the target person in the target visible-light image frame, determining the locating information of the target person in the depth image. The depth image frame is obtained by converting the target visible-light image frame, in which case the locating information in the target visible-light image frame may be directly determined to be the locating information in the depth image frame.

Step 2: collecting the pixel-depth values within the locating block of the target person in the depth image frame, and, according to the pixel-depth values, determining the photographing distance of the target person, wherein the locating block is determined based on the locating information of the target person.

It can be understood that the depth image frame refers to an image that uses the distances (depths) from the two-light camera to the points of the person as the pixel-depth values, and, accordingly, the photographing distance of the person may be determined according to the pixel-depth values.

Certainly, the above two embodiments of determining the photographing distance are merely illustrative, and should not be construed as a limitation.

According to the temperature correcting method according to the multiple above-described embodiments of the present disclosure, the present embodiment further provides an example of utilizing the temperature that has been corrected to track a fever person. In this example, a fever person may be tracked based on the tracking ID in the above-described tracking information. The method of tracking a fever person may include the following three steps:

The first step: according to the target temperatures that have been corrected of the persons and a preset temperature threshold, determining a fever person in the target visible-light image frame, and acquiring a target tracking ID of the fever person. One target visible-light image frame may contain one or more fever persons, and the fever persons are individually tracked according to the unique target tracking ID corresponding to each of the persons.

The second step: from other reference image-frame pairs within a preset duration from the target reference image-frame pair, acquiring a plurality of visible-light image frames to be tracked having the target tracking ID. In a particular implementation, the photographing time of the target reference image-frame pair is used as the reference time, and the preset duration may be a duration before the reference time, a duration after the reference time or a duration containing the reference time. The other reference image-frame pairs within the preset duration from the target reference image-frame pair are multiple pairs, and the visible-light image frames of the reference image-frame pairs are selected to be the visible-light image frames to be tracked.

The third step: according to photographing times and photographing locations of the visible-light image frames to be tracked, tracking the fever person. Based on the multiple possibilities of the preset duration, the corresponding visible-light image frames to be tracked may be historical visible-light image frames and/or a latest visible-light image frame. In this case, this step may include, according to the photographing times and the photographing locations of the historical visible-light image frames, determining the historical movement trajectory of the fever person, and, based on the historical movement trajectory of the fever person, predicting a possible future movement trajectory. Alternatively, this step may further include, according to the photographing location of the latest visible-light image frame, determining the latest location of the fever person. Therefore, at least one of the historical movement trajectory, the possible future movement trajectory and the latest location may be used as the tracking information of the fever person.

In conclusion, the temperature correcting method according to the above-described embodiments takes into consideration the influence on the temperature measurement by the distance, and corrects the measured temperature according to the distance, which may, in non-contacting temperature measurement, effectively increase the accuracy of person temperature measurement.

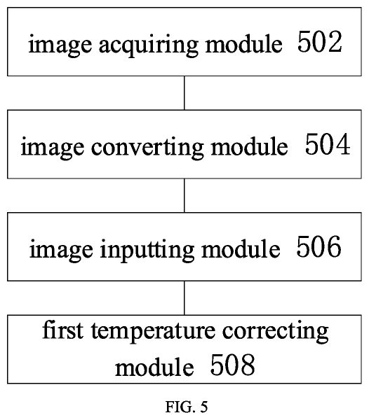

Referring to the structural block diagram of a temperature correcting apparatus shown in FIG. 5, the apparatus includes:

an image acquiring module 502 configured for acquiring a target reference image-frame pair containing a person, wherein the target reference image-frame pair includes a target visible-light image frame and a target thermal-imaging image frame;

an image converting module 504 configured for converting the target visible-light image frame into a depth image frame;

an image inputting module 506 configured for inputting the depth image frame and the target thermal-imaging image frame into an atmosphere-inverse-scattering model, wherein the atmosphere-inverse-scattering model refers to a neural network model obtained by fitting a relation between depths and temperature correcting values in advance; and

a first temperature correcting module 508 configured for, by using the atmosphere-inverse-scattering model, based on the depth image frame, performing temperature correction to the target thermal-imaging image frame, to obtain a target temperature.

As compared with the determination of the person temperature directly based on the detected target thermal-imaging image frame in the prior art, the temperature correcting apparatus according to the embodiment of the present disclosure, by using the atmosphere-inverse-scattering model to perform the temperature correction, cannot only ensure a high efficiency of the temperature detection, but also effectively utilizes the relation between the depths and the temperature correcting values to correct the person temperature, thereby obtaining a more accurate result. Because the depth indicates the distance between the camera and the person, such a mode takes into consideration and corrects the influence on the temperature by the distance, which may, in non-contacting temperature measurement, effectively increase the accuracy of person temperature measurement.

In one or more embodiments, the temperature correcting apparatus further includes a tracking module (not shown in the drawings), and the tracking module is configured for: according to a tracking algorithm, determining tracking information of the person in the target visible-light image frame, wherein the tracking information includes locating information and a tracking ID; the locating information includes position information of a human face and/or a human body in the target visible-light image frame; and the tracking ID is configured for identifying different persons in the target visible-light image frame, and a same person has a same tracking ID in different visible-light image frames.

In one or more embodiments, the first temperature correcting module 508 is further configured for: by using the atmosphere-inverse-scattering model, according to the locating information of a target person, extracting pixel-depth values of the depth image frame and pixel-temperature values of the target thermal-imaging image frame, wherein the target person is determined based on the tracking ID; according to the relation between the depths and the temperature correcting values, determining temperature correcting values corresponding to the pixel-depth values; and according to the temperature correcting values, correcting the pixel-temperature values, to obtain a target temperature of the target person.

In one or more embodiments, the first temperature correcting module 508 is further configured for: by using the relation between the depths and the temperature correcting values in the atmosphere-inverse-scattering model, based on the depth image frame, determining a first temperature correcting value; and according to the first temperature correcting value and a predetermined temperature-correction factor, performing temperature correction to the target thermal-imaging image frame, to obtain a target temperature of a target person, wherein the predetermined temperature-correction factor includes a gender-age correction factor and/or a time correction factor, and the target person is determined based on the tracking ID.

In one or more embodiments, the first temperature correcting module 508 is further configured for: according to the gender-age correction factor and a predetermined gender-age mapping table, determining a second temperature correcting value of the target person, wherein the gender-age mapping table records the temperature correcting values that correspond to different genders and different age intervals; and/or, according to the time correction factor and a predetermined time mapping table, determining a third temperature correcting value of the target person, wherein the time mapping table records the temperature correcting values that correspond to different time intervals; according to a preset weight, weighting the first temperature correcting value with the second temperature correcting value and/or the third temperature correcting value, to obtain a target temperature correcting value; and according to the target temperature correcting value, correcting the pixel-temperature values within a locating block of the target thermal-imaging image frame, to obtain the target temperature of the target person, wherein the locating block is determined based on the locating information of the target person.

In one or more embodiments, the first temperature correcting module 508 is further configured for: according to the first temperature correcting value, correcting the pixel-temperature values within the locating block of the target thermal-imaging image frame, to obtain a first corrected thermal-imaging image frame of the target thermal-imaging image frame, wherein the locating block is determined based on the locating information of the target person; and according to the gender-age correction factor and/or the time correction factor, performing secondary correction to pixel-temperature values within a locating block of the first corrected thermal-imaging image frame, to obtain a target temperature of the target person.

In one or more embodiments, the first temperature correcting module 508 is further configured for: according to the gender-age correction factor, performing second-time correction to the pixel-temperature values distributed within the locating block of the first corrected thermal-imaging image frame, to obtain a second corrected thermal-imaging image frame; according to the time correction factor, performing third-time correction to the pixel-temperature values distributed within the locating block of the second corrected thermal-imaging image frame, to obtain a third corrected thermal-imaging image frame; and according to the pixel-temperature values that have been corrected that are distributed within the locating block of the third corrected thermal-imaging image frame, determining the target temperature of the target person.

In one or more embodiments, the first temperature correcting module 508 is further configured for: extracting a human-face feature of the target person in the target visible-light image frame; according to the human-face feature, identifying gender-age information of the target person; and according to the gender-age information and the preset gender-age mapping table, performing secondary correction to pixel-temperature values distributed within the locating block of the first corrected thermal-imaging image frame, wherein the gender-age mapping table records the temperature correcting values that correspond to different genders and different age intervals.

In one or more embodiments, the first temperature correcting module 508 is further configured for: acquiring a photographing time of the target reference image-frame pair; and according to the photographing time and the preset time mapping table, performing secondary correction to pixel-temperature values distributed within the locating block of the first corrected thermal-imaging image frame, wherein the time mapping table records the temperature correcting values that correspond to different time intervals.

In one or more embodiments, the temperature correcting apparatus further includes a second temperature correcting module (not shown in the drawings), and the second temperature correcting module is configured for: according to the target visible-light image frame, determining a photographing distance between the person and a device photographing the target reference image-frame pair; and based on the photographing distance and a predetermined temperature-correction factor, performing temperature correction to the target thermal-imaging image frame, wherein the predetermined temperature-correction factor includes a gender-age correction factor and/or a time correction factor.

In one or more embodiments, the second temperature correcting module is further configured for: according to position information corresponding to a human face of a target person in the target visible-light image frame, determining a pixel ratio of a human-face region of the target person to the target visible-light image frame, wherein the target person is determined based on the tracking ID; and according to the pixel ratio, determining the photographing distance between the target person and the device photographing the target reference image-frame pair.

In one or more embodiments, the image acquiring module 502 is further configured for: by using a two-light camera, performing image acquisition to a specified region, to obtain a plurality of original reference image-frame pairs, wherein the two-light camera includes a visible-light camera and an infrared camera, and an original visible-light image frame collected by the visible-light camera and an original thermal-imaging image frame collected by the infrared camera correspond to each other, to form each of the original reference image-frame pairs; by performing human-face detection to the original visible-light image frames, determining the target visible-light image frame containing the person among the original visible-light image frames; and determining the original reference image-frame pair corresponding to the target visible-light image frame to be the target reference image-frame pair containing the person.

In one or more embodiments, the image converting module 504 is further configured for: inputting the target visible-light image frame into a predetermined depth-image converting model, and by using the depth-image converting model, converting the target visible-light image frame into the depth image frame.

In one or more embodiments, the temperature correcting apparatus further includes a fever-person tracking module (not shown in the drawings), and the fever-person tracking module is configured for: according to the target temperatures of the persons and a preset temperature threshold, determining a fever person in the target visible-light image frame, and acquiring a target tracking ID of the fever person; from other reference image-frame pairs within a preset duration from the target reference image-frame pair, acquiring a plurality of visible-light image frames to be tracked having the target tracking ID; and according to photographing times and photographing locations of the visible-light image frames to be tracked, tracking the fever person.

The principle of the implementation and the obtained technical effects of the apparatus according to the present embodiment are the same as those of the process embodiments stated above. In order to simplify the description, the contents that are not mentioned in the present embodiment may refer to the corresponding contents described above.

On the basis of the above-described embodiments, the present embodiment provides a temperature correcting system, wherein the system includes: an image collecting device, a processor and a storage device; the image collecting device is configured for collecting a target reference image-frame pair; and the storage device stores a computer program, and the computer program, when executed by the processor, executes the steps of the method stated herein, especially the temperature correcting method of any one of the items according to the method stated above.

A person skilled in the art may clearly understand that, in order for the convenience and concision of the description, the particular working process of the above-described system may refer to the corresponding processes according to the above-described process embodiments, and is not discussed here further.

Optionally, the present embodiment further provides a computer-readable storage medium, the computer-readable storage medium storing a computer program, wherein the computer program, when executed by a processing device, implements the steps of the method stated herein, especially the steps of the method stated above.

The computer program product for the temperature correcting method, apparatus and system according to the embodiments of the present disclosure includes a computer-readable storage medium storing a program code, and an instruction contained in the program code may be configured to implement the method according to the above-described process embodiments, the particular implementations of which may refer to the process embodiments, and are not discussed here further.

The functions, if implemented in the form of software function units and sold or used as an independent product, may be stored in a computer-readable storage medium. On the basis of such a comprehension, the substance of the technical solutions according to the present disclosure, or the part thereof that makes a contribution over the prior art, or part of the technical solutions, may be embodied in the form of a software product. The computer software product is stored in a storage medium, and contains multiple instructions configured so that a computer device (which may be a personal computer, a server, a network device and so on) implements all or some of the steps of the methods according to the embodiments of the present disclosure. Moreover, the above-described storage medium includes various media that may store a program code, such as a USB flash disk, a mobile hard disk drive, a read-only memory (ROM), a random access memory (RAM), a diskette and an optical disc.

Finally, it should be noted that the embodiments described above are merely particular embodiments of the present disclosure, and are intended to explain the technical solutions of the present disclosure, and not to limit them, and the protection scope of the present disclosure is not limited thereto. Although the present disclosure is explained in detail with reference to the above embodiments, a person skilled in the art should understand that a person skilled in the art may, within the technical scope disclosed by the present disclosure, easily envisage modifications or variations on the technical solutions set forth in the above embodiments, or make equivalent substitutions to some of the technical features thereof, and those modifications, variations or substitutions do not make the essence of the corresponding technical solutions depart from the spirit and scope of the technical solutions of the embodiments of the present disclosure, and should all be encompassed by the protection scope of the present disclosure. Therefore, the protection scope of the present disclosure should be subject to the protection scope of the appended claims.

### INDUSTRIAL APPLICABILITY

The present disclosure, by using the atmosphere-inverse-scattering model to perform the temperature correction, may not only ensure a high efficiency of the temperature detection, but also effectively utilizes the relation between the depths and the temperature correcting values to correct the person temperature, thereby obtaining a more accurate result. Because the depth indicates the distance between the camera and the person, such a mode takes into consideration and corrects the influence on the temperature by the distance, which may, in non-contacting temperature measurement, effectively increase the accuracy of person temperature measurement.

1. A temperature correcting method, wherein the method comprises:
acquiring a target reference image-frame pair containing a person, wherein the target reference image-frame pair comprises a target visible-light image frame and a target thermal-imaging image frame;
converting the target visible-light image frame into a depth image frame;
inputting the depth image frame and the target thermal-imaging image frame into an atmosphere-inverse-scattering model, wherein the atmosphere-inverse-scattering model refers to a neural network model obtained by fitting a relation between depths and temperature correcting values in advance; and
by using the atmosphere-inverse-scattering model, based on the depth image frame, performing temperature correction to the target thermal-imaging image frame, to obtain a target temperature.

2. The method according to claim 1, wherein the method further comprises:
according to a tracking algorithm, determining tracking information of the person in the target visible-light image frame, wherein the tracking information comprises locating information and a tracking ID;
the locating information comprises position information of a human face and/or a human body in the target visible-light image frame; and
the tracking ID is configured for identifying different persons in the target visible-light image frame, and a same person has a same tracking ID in different visible-light image frames.

3. The method according to claim 2, wherein the step of, by using the atmosphere-inverse-scattering model, based on the depth image frame, performing temperature correction to the target thermal-imaging image frame, to obtain the target temperature comprises:
by using the atmosphere-inverse-scattering model, according to the locating information of a target person, extracting pixel-depth values of the depth image frame and pixel-temperature values of the target thermal-imaging image frame, wherein the target person is determined based on the tracking ID;
according to the relation between the depths and the temperature correcting values, determining temperature correcting values corresponding to the pixel-depth values; and
according to the temperature correcting values, correcting the pixel-temperature values, to obtain a target temperature of the target person.

4. The method according to claim 2, wherein the step of, by using the atmosphere-inverse-scattering model, based on the depth image frame, performing temperature correction to the target thermal-imaging image frame, to obtain the target temperature comprises:
by using the relation between the depths and the temperature correcting values in the atmosphere-inverse-scattering model, based on the depth image frame, determining a first temperature correcting value; and
according to the first temperature correcting value and a predetermined temperature-correction factor, performing temperature correction to the target thermal-imaging image frame, to obtain a target temperature of a target person, wherein the predetermined temperature-correction factor comprises a gender-age correction factor and/or a time correction factor, and the target person is determined based on the tracking ID.

5. The method according to claim 4, wherein the step of, according to the first temperature correcting value and the predetermined temperature-correction factor, performing temperature correction to the target thermal-imaging image frame, to obtain the target temperature of the target person comprises:
according to the gender-age correction factor and a predetermined gender-age mapping table, determining a second temperature correcting value of the target person, wherein the gender-age mapping table records the temperature correcting values that correspond to different genders and different age intervals; and/or, according to the time correction factor and a predetermined time mapping table, determining a third temperature correcting value of the target person, wherein the time mapping table records the temperature correcting values that correspond to different time intervals;
according to a preset weight, weighting the first temperature correcting value with the second temperature correcting value and/or the third temperature correcting value, to obtain a target temperature correcting value; and
according to the target temperature correcting value, correcting the pixel-temperature values within a locating block of the target thermal-imaging image frame, to obtain the target temperature of the target person, wherein the locating block is determined based on the locating information of the target person.

6. The method according to claim 4, wherein the step of, according to the first temperature correcting value and the predetermined temperature-correction factor, performing temperature correction to the target thermal-imaging image frame, to obtain the target temperature of the target person comprises:
according to the first temperature correcting value, correcting the pixel-temperature values within the locating block of the target thermal-imaging image frame, to obtain a first corrected thermal-imaging image frame of the target thermal-imaging image frame, wherein the locating block is determined based on the locating information of the target person; and
according to the gender-age correction factor and/or the time correction factor, performing secondary correction to pixel-temperature values within a locating block of the first corrected thermal-imaging image frame, to obtain the target temperature of the target person.

7. The method according to claim 6, wherein the step of, according to the gender-age correction factor and/or the time correction factor, performing secondary correction to pixel-temperature values within the locating block of the first corrected thermal-imaging image frame, to obtain the target temperature of the target person comprises:
according to the gender-age correction factor, correcting the pixel-temperature values distributed within the locating block of the first corrected thermal-imaging image frame, to obtain a second corrected thermal-imaging image frame;
according to the time correction factor, correcting the pixel-temperature values distributed within the locating block of the second corrected thermal-imaging image frame, to obtain a third corrected thermal-imaging image frame; and
according to the pixel-temperature values that have been corrected that are distributed within the locating block of the third corrected thermal-imaging image frame, determining the target temperature of the target person.

8. The method according to claim 6, wherein the step of, according to the gender-age correction factor and/or the time correction factor, performing secondary correction to pixel-temperature values within the locating block of the first corrected thermal-imaging image frame, to obtain the target temperature of the target person comprises:
according to the time correction factor, correcting the pixel-temperature values distributed within the locating block of the first corrected thermal-imaging image frame, to obtain a second corrected thermal-imaging image frame;
according to the gender-age correction factor, correcting the pixel-temperature values distributed within the locating block of the second corrected thermal-imaging image frame, to obtain a third corrected thermal-imaging image frame; and
according to the pixel-temperature values that have been corrected that are distributed within the locating block of the third corrected thermal-imaging image frame, determining the target temperature of the target person.

9. The method according to claim 6, wherein the step of, according to the gender-age correction factor, performing secondary correction to the pixel-temperature values within the locating block of the first corrected thermal-imaging image frame comprises:
extracting a human-face feature of the target person in the target visible-light image frame;
according to the human-face feature, identifying gender-age information of the target person; and
according to the gender-age information and a preset gender-age mapping table, performing secondary correction to pixel-temperature values distributed within the locating block of the first corrected thermal-imaging image frame, wherein the gender-age mapping table records the temperature correcting values that correspond to different genders and different age intervals.

10. The method according to claim 6, wherein the step of, according to the time correction factor, performing secondary correction to the pixel-temperature values within the locating block of the first corrected thermal-imaging image frame comprises:
acquiring a photographing time of the target reference image-frame pair; and
according to the photographing time and a preset time mapping table, performing secondary correction to pixel-temperature values distributed within the locating block of the first corrected thermal-imaging image frame, wherein the time mapping table records the temperature correcting values that correspond to different time intervals.

11. The method according to claim 1, wherein the method further comprises:
according to the target visible-light image frame, determining a photographing distance between the person and a device photographing the target reference image-frame pair; and
based on the photographing distance and a predetermined temperature-correction factor, performing temperature correction to the target thermal-imaging image frame, wherein the predetermined temperature-correction factor comprises a gender-age correction factor and/or a time correction factor.

12. The method according to claim 11, wherein the step of, according to the target visible-light image frame, determining the photographing distance between the person and the device photographing the target reference image-frame pair comprises:
according to position information corresponding to a human face of a target person in the target visible-light image frame, determining a pixel ratio of a human-face region of the target person to the target visible-light image frame, wherein the target person is determined based on the tracking ID; and
according to the pixel ratio, determining the photographing distance between the target person and the device photographing the target reference image-frame pair.

13. The method according to claim 1, wherein the step of acquiring the target reference image-frame pair containing the person comprises:
by using a two-light camera, performing image acquisition to a specified region, to obtain a plurality of original reference image-frame pairs, wherein the two-light camera comprises a visible-light camera and an infrared camera, and an original visible-light image frame collected by the visible-light camera and an original thermal-imaging image frame collected by the infrared camera correspond to each other, to form each of the original reference image-frame pairs;
by performing human-face detection to the original visible-light image frames, determining the target visible-light image frame containing the person among the original visible-light image frames; and
determining the original reference image-frame pair corresponding to the target visible-light image frame to be the target reference image-frame pair containing the person.

14. The method according to claim 1, wherein the step of converting the target visible-light image frame into the depth image frame comprises:
inputting the target visible-light image frame into a predetermined depth-image converting model, and by using the depth-image converting model, converting the target visible-light image frame into the depth image frame.

15. The method according to claim 2, wherein the method further comprises:
according to the target temperatures of the persons and a preset temperature threshold, determining a fever person in the target visible-light image frame, and acquiring a target tracking ID of the fever person;
from other reference image-frame pairs within a preset duration from the target reference image-frame pair, acquiring a plurality of visible-light image frames to be tracked having the target tracking ID; and
according to photographing times and photographing locations of the visible-light image frames to be tracked, tracking the fever person.

16. (canceled)

17. A temperature correcting system, wherein the system comprises: an image collecting device, a processor and a storage device;
the image collecting device is configured for collecting a target reference image-frame pair; and
the storage device stores a computer program, and the computer program, when executed by the processor, executes the method according to claim 1.

18. A computer-readable storage medium, the computer-readable storage medium storing a computer program, wherein the computer program, when executed by a processor, executes the steps of the method according to claim 1.

19. The method according to claim 2, wherein the method further comprises:
according to the target visible-light image frame, determining a photographing distance between the person and a device photographing the target reference image-frame pair; and
based on the photographing distance and a predetermined temperature-correction factor, performing temperature correction to the target thermal-imaging image frame, wherein the predetermined temperature-correction factor comprises a gender-age correction factor and/or a time correction factor.

20. The method according to claim 3, wherein the step of, by using the atmosphere-inverse-scattering model, based on the depth image frame, performing temperature correction to the target thermal-imaging image frame, to obtain the target temperature comprises:
by using the relation between the depths and the temperature correcting values in the atmosphere-inverse-scattering model, based on the depth image frame, determining a first temperature correcting value; and
according to the first temperature correcting value and a predetermined temperature-correction factor, performing temperature correction to the target thermal-imaging image frame, to obtain a target temperature of a target person, wherein the predetermined temperature-correction factor comprises a gender-age correction factor and/or a time correction factor, and the target person is determined based on the tracking ID.

21. The method according to claim 7, wherein the step of, according to the gender-age correction factor, performing secondary correction to the pixel-temperature values within the locating block of the first corrected thermal-imaging image frame comprises:
extracting a human-face feature of the target person in the target visible-light image frame;
according to the human-face feature, identifying gender-age information of the target person; and
according to the gender-age information and a preset gender-age mapping table, performing secondary correction to pixel-temperature values distributed within the locating block of the first corrected thermal-imaging image frame, wherein the gender-age mapping table records the temperature correcting values that correspond to different genders and different age intervals.
